(19) United States
(12) Patent Application Publication
(10) Pub. No.: US 2023/0087635 A1
(43) Pub. Date: Mar. 23, 2023

(54) BATTERY MODULE, BATTERY PACK COMPRISING SAME, AND VEHICLE COMPRISING SAME

(71) Applicant: LG ENERGY SOLUTION, LTD., Seoul (KR)

(72) Inventors: Do-Wung SON, Daejeon (KR); Yong-Shik SHIN, Daejeon (KR); Young-Jin KIM, Daejeon (KR); Seung-Hyun YUN, Daejeon (KR); Byeong-Yoon JUNG, Daejeon (KR); Sung-Man CHOI, Daejeon (KR)

(21) Appl. No.: 17/791,868

(22) PCT Filed: Oct. 5, 2021
(86) PCT No.: PCT/KR2021/013639

§ 371 Date: Jul. 8, 2022

(30) Foreign Application Priority Data
Oct. 29, 2020 (KR) 10-2020-0141902

(51) Int. Cl. H01M 50/505; H01M 50/567

(52) U.S. Cl. CPC H01M 50/505; H01M 50/567; H01M 2220/20

(57) ABSTRACT

A battery module, a battery pack including the same, and a vehicle including the same are provided. The battery module includes a stack of battery cells; a cover accommodating the stack of battery cells; and a bus bar electrically connecting the battery cells; a relay comprising a connection terminal coupled to the bus bar; and a joint block coupled to the bus bar and the connection terminal of the relay.

### CROSS-REFERENCE TO RELATED APPLICATION

The present application is a National Stage Application of International Application No. PCT/KR2021/013639, filed on Oct. 5, 2021, which claims priority to Korean Patent Application No. 10-2020-0141902 filed on Oct. 29, 2020, the disclosures of which are incorporated herein by reference in their entirety.

### FIELD OF DISCLOSURE

The present disclosure relates to a battery module, a battery pack including the same and a vehicle including the battery module, and more particularly, to a battery module capable of easily coupling a relay to a bus bar, a battery pack including the same and a vehicle including the battery module.

### BACKGROUND

As technology development of and demand for mobile devices increase, the demand for secondary batteries as an energy source is rapidly increasing. Although nickel cadmium batteries or hydrogen ion batteries have been used as secondary batteries of the related art, because the batteries have almost no memory effect compared to nickel-based secondary batteries, recently, lithium secondary batteries that are freely charged and discharged, have very low self-discharge rate, and have high energy density have been widely used.

Such a lithium secondary battery mainly uses lithium-based oxides and carbon materials as positive electrode active materials and negative electrode active materials, respectively. The lithium secondary battery includes an electrode assembly in which a positive electrode plate and a negative electrode plate on which a positive electrode active material and a negative electrode active material are respectively coated are arranged with a separator interposed therebetween, and a sheath material, that is, a battery case, that seals and accommodates the assembly together with an electrolyte solution.

The lithium secondary battery includes a positive electrode, a negative electrode, a separator interposed therebetween, and an electrolyte, and includes a lithium ion battery (LIB), a polymer lithium ion battery (PLIB), etc. according to which positive electrode active material and negative electrode active material are used. In general, the electrodes of the lithium secondary batteries are formed by coating a positive electrode active material or a negative electrode active material on a current collector such as an aluminum or copper sheet, a mesh, a film, or a foil, and then drying the positive electrode active material or the negative electrode active material. In addition, various types of secondary batteries have a cover capable of protecting a plurality of battery cells, and include a plurality of battery modules in which the plurality of battery cells are stacked and drawn into the cover, and a battery pack including the plurality of battery modules.

The battery cells may be electrically connected to each other through a bus bar that is a conductor. In general, a positive electrode lead is manufactured of an aluminum material, a negative electrode lead is manufactured of a copper material, and the bus bar is also manufactured of a copper material.

Meanwhile, a relay selectively opening/closing a charging/discharging path through which current flows may be coupled to the battery module and connected to the bus bar.

However, one side of the bus bar is connected to the battery cells and the other side thereof is connected to the relay. Because a part of the bus bar connected to the battery cell is surrounded by a cover of the battery module and only a part of the bus bar connected to the relay partially protrudes toward an outside of the cover, there is a problem in that coupling of the relay and the bus bar is not easy because an operator's hand hits the cover in order to connect the relay to the bus bar.

### SUMMARY

The present disclosure is designed to solve the problems of the related art, and therefore the present disclosure is directed to providing a battery module capable of easily coupling a relay to a bus bar, a battery pack including the same, and a vehicle including the battery module.

In one aspect of the present disclosure, there is provided a battery module including a stack of battery cells; a cover accommodating the stack of battery cells; and a bus bar electrically connecting the battery cells; a relay comprising a connection terminal coupled to the bus bar; and a joint block coupled to the bus bar and the connection terminal of the relay.

A first fastening hole may be formed in the bus bar, a second fastening hole may be formed in the connection terminal of the relay, a protruding bolt may be integrally formed on the joint block, and the protruding bolt may be inserted into the first fastening hole and the second fastening hole and fastened to a nut.

A first fastening hole may be formed in the bus bar, a second fastening hole may be formed in the connection terminal of the relay, a third fastening hole in which a female screw is formed may be formed in the joint block, and a fastening bolt may be inserted into the second fastening hole and the first fastening hole, and may be fastened to the female screw of the third fastening hole.

The fastening bolt may be inserted into the second fastening hole, the first fastening hole, and the third fastening hole sequentially and fixed.

The joint block may include a main body; a seating groove formed in the main body such that the bus bar and the connection terminal are seated therein; and the third fastening hole formed inside the seating groove.

A guide portion may be formed in the seating groove so that the first fastening hole of the bus bar, the second fastening hole of the connection terminal of the relay, and the third fastening hole are aligned.

The guide portion may be an inclined guide comprising an inclination formed along a circumference of the seating groove.

The inclined guide may be formed such that the bus bar and the connection terminal descend toward the third fastening hole along the inclined guide.

In another aspect of the present disclosure, there is provided a battery pack including the battery module described above and a vehicle including the battery module.

### Advantageous Effects

The embodiments of the present disclosure may easily couple a relay to a bus bar through a joint block.

### DESCRIPTION OF DRAWINGS

FIG. 1 is a schematic overall perspective view of a battery module according to an embodiment of the present disclosure.

FIG. 2 illustrates a part of a bus bar in the battery module according to an embodiment of the present disclosure.

FIG. 3 is a perspective view illustrating a relay and a bus bar coupled by a joint block according to an embodiment in the battery module according to an embodiment of the present disclosure.

FIG. 4 is a perspective view illustrating a relay and a bus bar coupled by a joint block in FIG. 3.

FIG. 5 is a perspective view illustrating a relay and a bus bar coupled by a joint block according to another embodiment different from FIG. 3.

FIG. 6 is a perspective view illustrating a relay and a bus bar coupled by a joint block in FIG. 5.

FIG. 7 is a perspective view of a guide portion formed in a joint block according to another embodiment different from FIG. 5.

FIGS. 8 to 10 illustrate a process of guiding and fastening a relay and a bus bar along the guide portion of the joint block of FIG. 7.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the scope of the disclosure.

In the drawings, the size of each element or a specific portion constituting the element is exaggerated, omitted, or schematically illustrated for convenience and clarity of description. Accordingly, the size of each element does not fully reflect the actual size. If it is determined that a detailed description of a related known function or configuration may unnecessarily obscure the gist of the present disclosure, such description will be omitted.

As used herein, the term ‘couple’ or ‘connect’ includes not only a case where one member is directly coupled or directly connected to another member, but also a case where one member is indirectly coupled or indirectly connected to another member through a joint member.

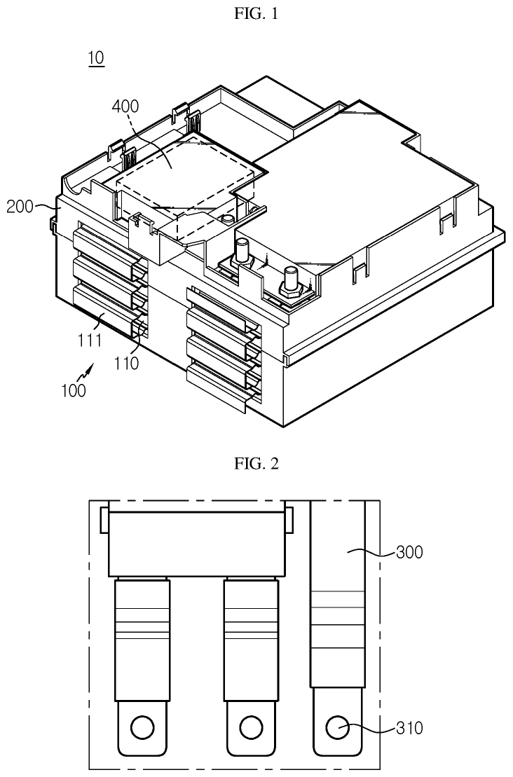

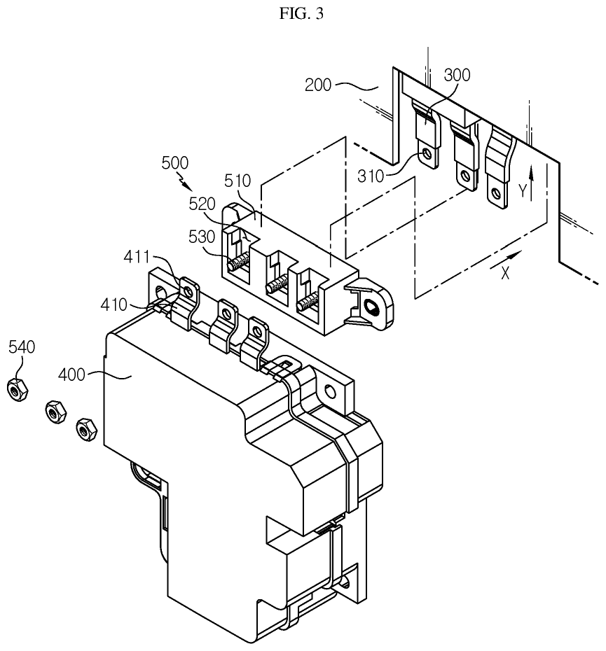

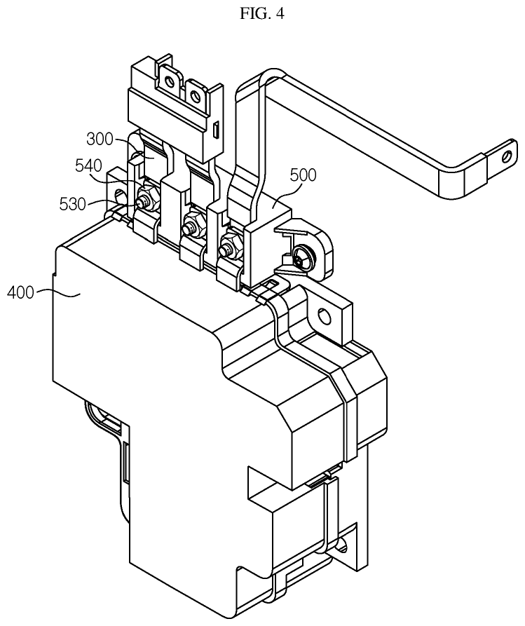

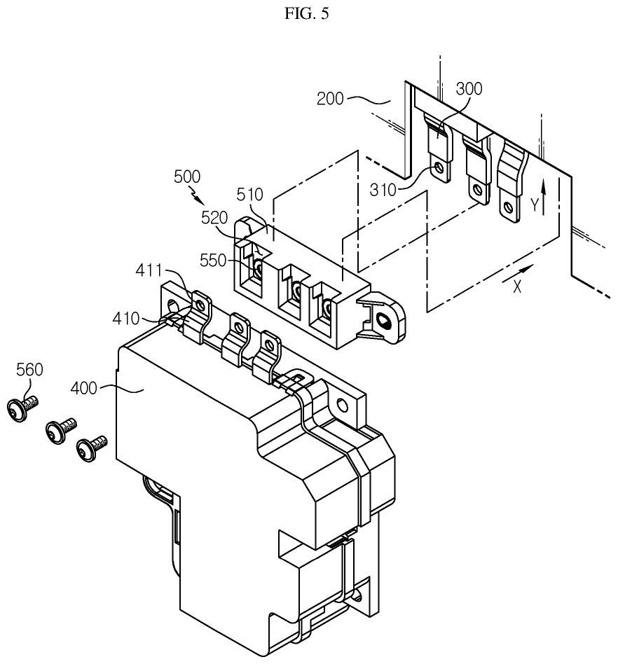

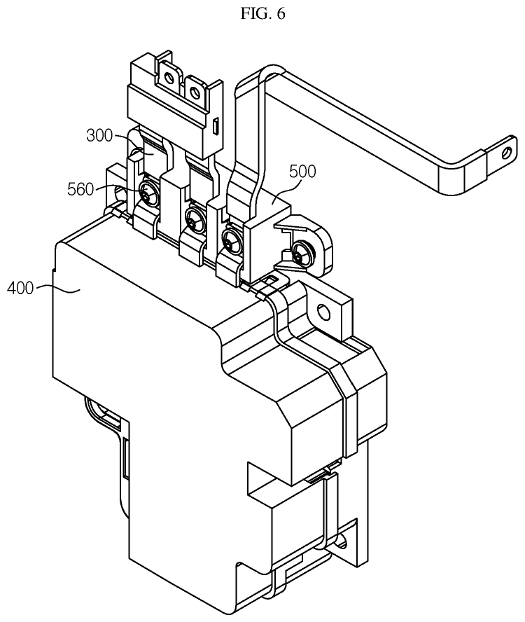

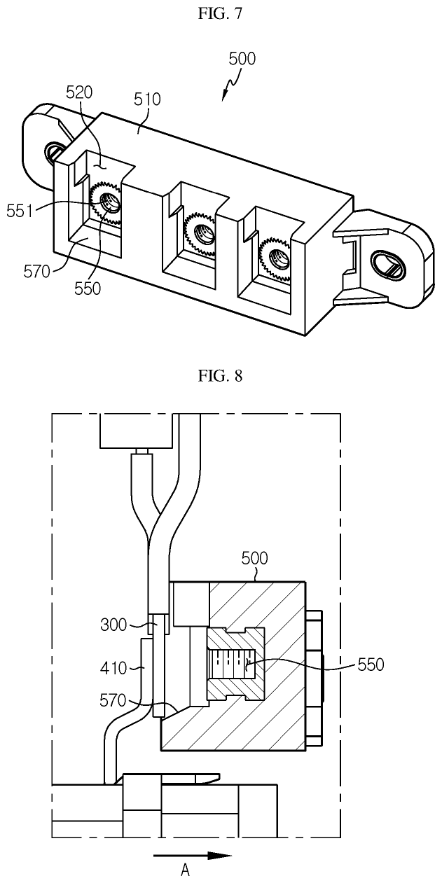

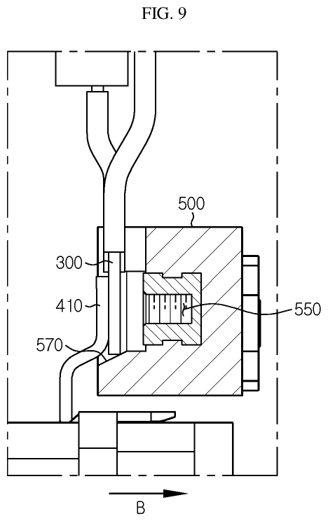

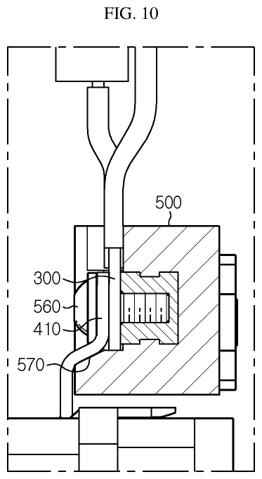

FIG. 1 is a schematic overall perspective view of a battery module according to an embodiment of the present disclosure, FIG. 2 illustrates a part of a bus bar in the battery module according to an embodiment of the present disclosure, FIG. 3 is a perspective view illustrating a relay and a bus bar coupled by a joint block according to an embodiment in the battery module according to an embodiment of the present disclosure, FIG. 4 is a perspective view illustrating a relay and a bus bar coupled by a joint block in FIG. 3, FIG. 5 is a perspective view illustrating a relay and a bus bar coupled by a joint block according to another embodiment different from FIG. 3, FIG. 6 is a perspective view illustrating a relay and a bus bar coupled by a joint block in FIG. 5, FIG. 7 is a perspective view of a guide portion formed in a joint block according to another embodiment different from FIG. 5, and FIGS. 8 to 10 illustrate a process of guiding and fastening a relay and a bus bar along the guide portion of the joint block of FIG. 7. In FIGS. 4 and 6, a cover is omitted.

Referring to the drawings, a battery module 10 according to an embodiment of the present disclosure includes a stack of battery cells 100, a cover 200, a bus bar 300, a relay 400, and a joint block 500.

Referring to FIG. 1, a plurality of battery cells 110 comprising electrode leads 111 are stacked in the stack of battery cells 100. The electrode leads 111 comprised in the battery cell 110 are a kind of terminal exposed to the outside and are connected to an external device, and a conductive material may be used therefor.

The electrode leads 111 may include a positive electrode lead and a negative electrode lead. The positive electrode lead and the negative electrode lead may be disposed in opposite directions with respect to the longitudinal direction of the battery cell 110, or the positive electrode lead and the negative electrode lead may be located in the same direction with respect to the longitudinal direction of the battery cell 110.

The positive electrode lead and the negative electrode lead may be made of various materials. For example, the positive electrode lead may be manufactured of an aluminum material, and the negative electrode lead may be manufactured of a copper material.

The electrode leads 111 may be electrically coupled to the bus bar 300. The battery cell 110 may have a structure in which a plurality of unit cells or a plurality of bi-cells are stacked according to the capacity, wherein positive electrode plate-separator-negative electrode plate are sequentially arranged in a unit cell, and positive electrode plate-separator-negative electrode plate-separator-positive electrode plate-separator-negative electrode plate are sequentially arranged in a bi-cell.

The stack of battery cells 100 may be configured such that the plurality of battery cells 110 are stacked on each other. Here, the battery cells 110 may have various structures, and the plurality of battery cells 110 may be stacked in various ways.

A plurality of cartridges (not shown) respectively accommodating the battery cells 110 may be provided on the stack of battery cells 100. Each cartridge (not shown) may be manufactured by injection molding of plastic, and the plurality of cartridges (not shown) in which an accommodating unit capable of accommodating the battery cell 110 is formed may be stacked.

A connector element or a terminal element may be provided on a cartridge assembly in which the plurality of cartridges (not shown) are stacked. The connector element may include, for example, various types of electrical connection components or connection members for connection to a battery management system (BMS, not shown) capable of providing data on the voltage or temperature of the battery cell 110, etc.

In addition, the terminal element includes a positive electrode terminal and a negative electrode terminal as a main terminal connected to the battery cell 110, and a terminal bolt is provided on the terminal element to be electrically connected to the outside. Meanwhile, the battery cell 110 may have various shapes.

Referring to FIG. 1, the stack of battery cells 100 or a cartridge assembly in which the stack of battery cells 100 is accommodated in the cover 200. For example, the cover 200 may be provided to surround the stack of battery cells 100.

The relay 400 is disposed on the cover 200, and the relay 400 is coupled to the bus bar 300 connected to the battery cell 110.

The cover 200 surrounds the stack of battery cells 100 or all of a plurality of cartridge assemblies, thereby protecting the stack of battery cells 100 or the cartridge assemblies from external vibration or impact.

The cover 200 may be formed in a shape corresponding to the shape of the stack of battery cells 100 or the cartridge assembly. For example, when the stack of battery cells 100 or the cartridge assembly is provided in a hexahedral shape, the cover 200 may also be provided in the hexahedral shape to correspond thereto.

The cover 200 may be manufactured by, for example, bending a plate of a metal material, or may be manufactured by plastic injection mold. Also, the cover 200 may be manufactured integrally or may be manufactured separately.

A penetration unit (not shown) through which the connector element or the terminal element described above may be exposed to the outside may be formed in the cover 200. That is, the connector element or the terminal element may be electrically connected to a predetermined external component or member, and the penetration unit may be formed in the cover 200 so that the electrical connection is not obstructed by the cover 200.

The bus bar 300 is coupled to the electrode leads 111 provided in each of the plurality of battery cells 110, and electrically connects the respective electrode leads 111 to each other. In FIGS. 3 and 5, a part of the bus bar 300 connected to the battery cell 110 accommodated inside the cover 200 is exposed to the outside of the cover 200. Here, the bus bar 300 is manufactured of a flexible material that is bendable.

Referring to FIGS. 2, 3 and 5, a first fastening hole 310 is formed in the bus bar 300. The first fastening hole 310 of the bus bar 300 is fastened after being centered with a second fastening hole 411 formed in a connection terminal 410 of the relay 400 to be described below.

The relay 400 is connected to the battery cell 110 through the bus bar 300 and switches the flow of current in the battery cell 110. A connection terminal 410 is provided in the relay 400. In addition, the second fastening hole 411 is formed in the connection terminal 410 of the relay 400, and the relay 400 may be coupled to the bus bar 300 through the second fastening hole 411 formed in the connection terminal 410 of the relay 400.

Here, the stack of battery cells 100 is accommodated in the cover 200 and connected to the bus bar 300, and the bus bar 300 may be provided to be coupled with the relay 400 in a state where a part of the bus bar 300 protrudes to the outside of the cover 200.

The joint block 500 is coupled to the connection terminal 410 of the bus bar 300 and the relay 400. Here, the bus bar 300 and the relay 400 may be coupled by the joint block 500. That is, referring to FIGS. 3 and 5, when the bus bar 300 and the connection terminal 410 of the relay 400 are directly fastened through a bolt and a nut, because an operator's hand hits the cover 200, a work is not easy. In order to solve this problem, the battery module 10 according to an embodiment of the present disclosure includes the joint block 500.

As an embodiment, referring to FIG. 3, the joint block 500 may include a main body 510, a seating groove 520, and a protruding bolt 530.

The seating groove 520 and the protruding bolt 530 are formed in the main body 510.

The seating groove 520 may be formed in the body 510 such that the bus bar 300 and the connection terminal 410 of the relay 400 are seated therein. Referring to FIG. 3, three seating grooves 520 are formed in the main body 510, but this is only an example and the number of seating grooves 520 is not limited thereto.

The protruding bolt 530 is formed in the main body 510, and a nut 540 is coupled thereto.

As another embodiment, referring to FIG. 5, the joint block 500 may include the main body 510, the seating groove 520, and a third fastening hole 550.

The seating groove 520 and the third fastening hole 550 are formed in the main body 510.

The seating groove 520 may be formed in the main body 510 such that the bus bar 300 and the connection terminal 410 are seated therein. Referring to FIG. 5, three seating grooves 520 are formed in the main body 510, but this is only an example and the number of seating grooves 520 is not limited thereto.

In addition, the third fastening hole 550 is formed inside the seating groove 520, and a female screw 551 (see FIG. 7) is formed in the third fastening hole 550. Here, FIGS. 5 and 7 differ only in whether a guide portion 570 is formed in the seating groove 520, and in both FIGS. 5 and 7, the female screw 551 is formed in the third fastening hole 550.

As another embodiment, referring to FIG. 7, the guide portion 570 may be formed in the seating groove 520.

Referring to FIG. 3, the protruding bolt 530 is integrally formed with the joint block 500 according to an embodiment. The joint block 500 is first moved in the X direction of FIG. 3 and then moved in the Y direction of FIG. 3 under the bus bar 300 so that the protruding bolt 530 formed in the joint block 500 is moved from the rear of the first fastening hole 310 of the bus bar 300 to the front, that is, in a direction opposite to the X direction of FIG. 3, and is inserted into the first fastening hole 310.

Then, the second fastening hole 411 formed in the connection terminal 410 of the relay 400 is inserted into the protruding bolt 530 of the joint block 500 inserted into the first fastening hole 310 and protruding toward the outside of the first fastening hole 310, and as shown in FIG. 4, the nut 540 is fastened to the protruding bolt 530 so that the bus bar 300, the joint block 500, and the relay 400 may be coupled. As described above, the cover 200 is omitted in FIG. 4.

Referring to FIG. 5, the third fastening hole 550 in which a female screw 551 (see FIG. 7) is formed is formed in the joint block 500 according to an embodiment different from FIG. 3. The joint block 500 is first moved in the X direction of FIG. 5 and then moved in the Y direction of FIG. 5 under the bus bar 300 so that the third fastening hole 550 formed in the joint block 500 is aligned to be centered while being located in the rear of the first fastening hole 310 of the bus bar 300.

Then, the second fastening hole 411 formed in the connection terminal 410 of the relay 400 is aligned to be centered with the first fastening hole 310 and the third fastening hole 550, and, as shown in FIG. 6, the fastening bolt 560 is inserted into the second fastening hole 411 and the first fastening hole 310, is fastened to the female screw 551 of the third fastening hole 550, so that the bus bar 300 and the joint block 500 and the relay 400 may be coupled. As described above, the cover is omitted in FIG. 6.

Here, referring to FIGS. 5 and 6, the fastening bolt 560 is inserted and fixed in the order of the second fastening hole 411, the first fastening hole 310, and the third fastening hole 550.

Referring to FIG. 7, the guide portion 570 may be formed in the seating groove 520. Here, the guide portion 570 may be an inclined guide comprising an inclination formed along the circumference of the seating groove 520. That is, the inclined guide may be formed such that the bus bar 300 and the connection terminal 410 descend toward the third fastening hole 550 along the inclined guide.

Accordingly, there is an effect that the relay 400 may be easily coupled to the bus bar 300 through the joint block 500.

Hereinafter, the operation and effect of the battery module 10 according to an embodiment of the present disclosure will be described with reference to the drawings.

Referring to FIG. 8, the connection terminal 410 of the relay 400 is in contact with the bus bar 300 and moves in the direction of an arrow A. At this time, referring to FIG. 9, the connection terminal 410 of the relay 400 and the bus bar 300 move in a direction of an arrow B while being in contact with each other and descend toward the third fastening hole 550 along the inclined guide of the guide portion 570 formed in the seating groove 520 of the join block 500.

That is, when the connection terminal 410 of the relay 400 and the bus bar 300 are in contact with each other and only move in the direction of the arrow A of FIG. 8, the connection terminal 410 of the relay 400 and the bus bar 300 move to the third fastening hole 550, and the second fastening hole 411 of the connection terminal 410 of the relay 400, the first fastening hole 310 of the bus bar 300, and the third fastening hole 550 of the joint block 500 are aligned to be precisely centered with each other without any alignment.

That is, in the battery module 10 according to an embodiment of the present disclosure, it is possible to align the first fastening hole 310, the second fastening hole 411, and the third fastening hole 550 without a special aligning operation, and accordingly, the first fastening hole 310, the second fastening hole 411, and the third fastening hole 550 may be fastened with the fastening bolt 560, and thus there is an effect that the relay 400 may be easily coupled to the bus bar 300 through the joint block 500.

Meanwhile, a battery pack (not shown) according to an embodiment of the present disclosure may include one or more battery modules 10 according to an embodiment of the present disclosure as described above. In addition, the battery pack (not shown) may further include a case accommodating the battery module 10, and various devices controlling the charging and discharging of the battery module 10, such as a BMS, a current sensor, a fuse, etc., in addition to the battery module 10.

Meanwhile, a vehicle (not shown) according to an embodiment of the present disclosure may include the battery module 10 or the battery pack (not shown) described above. The battery pack (not shown) may include the battery module 10. In addition, the battery module 10 according to an embodiment of the present disclosure may be applied to a vehicle (not shown), for example, a predetermined vehicle (not shown) provided to use electricity such as an electric vehicle or a hybrid vehicle.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

The present disclosure relates to a battery module, a battery pack including the same, and a vehicle including the battery module, and in particular, may be applicable to an industry related to a secondary battery.

1. A battery module comprising:
a stack of battery cells;
a cover accommodating the stack of battery cells;
a bus bar electrically connecting the battery cells;
a relay comprising a connection terminal coupled to the bus bar; and
a joint block coupled to the bus bar and the connection terminal of the relay.

2. The battery module of claim 1,
wherein a first fastening hole is formed in the bus bar,
a second fastening hole is formed in the connection terminal of the relay,
a protruding bolt is integrally formed on the joint block, and
the protruding bolt is inserted into the first fastening hole and the second fastening hole and fastened to a nut.

3. The battery module of claim 1,
wherein a first fastening hole is formed in the bus bar,
a second fastening hole is formed in the connection terminal of the relay,
a third fastening hole in which a female screw is formed is formed in the joint block, and
a fastening bolt is inserted into the second fastening hole and the first fastening hole, and is fastened to the female screw of the third fastening hole.

4. The battery module of claim 3, wherein the fastening bolt is inserted into the second fastening hole, the first fastening hole, and the third fastening hole sequentially and fixed.

5. The battery module of claim 3, wherein the joint block comprises:
a main body;
a seating groove formed in the main body such that the bus bar and the connection terminal are seated therein; and
the third fastening hole formed inside the seating groove.

6. The battery module of claim 5, wherein a guide portion is formed in the seating groove such that the first fastening hole of the bus bar, the second fastening hole of the connection terminal of the relay, and the third fastening hole are aligned.

7. The battery module of claim 6, wherein the guide portion is an inclined guide comprising an inclination is-formed along a circumference of the seating groove.

8. The battery module of claim 7, wherein the inclined guide is formed such that the bus bar and the connection terminal descend toward the third fastening hole along the inclined guide.

9. A battery pack comprising a battery module according to claim 1.

10. A vehicle comprising a battery module according to claim 1.
